(19) United States
(12) Patent Application Publication
(10) Pub. No.: US 2013/0272026 A1
(43) Pub. Date: Oct. 17, 2013

(54) LATERAL LIGHT SOURCE PROCESSING MODULE AND LIGHTING DEVICE WITH THE SAME

(71) Applicant: MING TANG YAO, New Taipei City (TW)

(72) Inventor: MING TANG YAO, New Taipei City (TW)

(73) Assignee: E-LON OPTRONICS CO., LTD., New Taipei City (TW)

(21) Appl. No.: 13/530,429

(22) Filed: Jun. 22, 2012

(30) Foreign Application Priority Data
Apr. 13, 2012 (TW) 101113345

(51) Int. Cl. F21V 13/02; F21V 7/00

(52) U.S. Cl. 362/609; 362/346

(57) ABSTRACT

A lateral light source processing module and a lighting device with the lateral light source processing module are provided. The lateral light source processing module includes a first surface and a second surface opposed to the first surface. In addition, plural saw-toothed structures are formed on the second surface. An included angle between any surface of any saw-toothed structure and a normal line perpendicular to the first surface is a specified angle. Consequently, the light beams projected on the saw-toothed structure are subject to total internal reflection. According to the specified angle, the reflected light beams are propagated along a corresponding direction.

### FIELD OF THE INVENTION

The present invention relates to a lateral light source processing module, and more particularly to a lateral light source processing module for use in a lighting device.

### BACKGROUND OF THE INVENTION

Generally, a light guide plate has a function for uniformly guiding the laterally received light beams to the whole light guide plate. For most of the lighting devices using the lateral light sources, the light beams provided by the lateral light sources are outputted to the surroundings through the light guide plates. In other words, the applications of the light guide plates are very extensive. For example, the light guide plate may be applied to a backlight module of a LCD panel or an illuminated keyboard. Alternatively, the light guide plate may be applied to an indoor lighting device or an outdoor lighting device.

FIG. 1 schematically illustrates the structure of a conventional light guide plate. Moreover, in FIG. 1, the optical paths of some of the light beams incident into the light guide plate are shown. The light guide plate 1 has a first surface 11 and a second surface 12, wherein the first surface 11 and the second surface 12 are opposed to each other. In addition, the first surface 11 and the second surface 12 are flat surfaces.

Furthermore, a light source (not shown) is located at a lateral side of the light guide plate 1 for providing plural light beams L1 to the light guide plate 1. Since the refractive index of the light guide plate 1 is higher than the refractive index of air, according to Snell's law, the light beams L1 incident into the light guide plate 1 are readily subject to total internal reflection within the light guide plate 1. Since the light beams L1 are continuously subject to the total internal reflection within the light guide plate 1, the light beams L1 at an end of the light guide plate 1 may be transferred to another end of the light guide plate 1. In such way, the light energy can be uniformly distributed within the light guide plate 1.

For outputting the light energy from the light guide plate 1 to the surroundings, plural light-outputting dots 13 are formed on the first surface 11 for destroying the total internal reflection. When the light beams L1 incident into the light guide plate 1 hit the light-outputting dots 13, the light beams L1 are externally refracted by the light-outputting dots 13. Consequently, the light beams L1′ are outputted to the surroundings. For example, the plural light-outputting dots 13 are formed on the first surface 11 by a printing process, an etching process, a cutting process, a lithography process, or a sand blasting process.

However, the conventional light guide plate 1 still has some drawbacks. For example, the overall surface of the light-outputting dots 13 is much smaller relative to the area of the first surface 11 of the light guide plate 1. Under this circumstance, the light energy stored in the light guide plate 1 fails to be effectively outputted to the surroundings, and thus the luminance of the light beams outputted from the light guide plate 1 is usually insufficient.

Moreover, in many occasions, the luminance of the output light and the power-saving efficacy are important for the device (e.g. the lighting device) with the light guide plate. That is, the uniformity of the output light is not so emphasized.

From the above discussions, the conventional light guide plate fails to meet these requirements. Therefore, there is a need of providing an approach to improve the conventional light guide plate.

### SUMMARY OF THE INVENTION

The present invention relates to a lateral light source processing module, and more particularly to a lateral light source processing module with high directivity and good light utilization efficiency.

The present invention further provides a lighting device with the lateral light source processing module.

In accordance with an aspect of the present invention, there is provided a lighting device. The lighting device includes a lateral light source processing module, at least one LED unit, and a light guide module. The lateral light source processing module includes a first surface and a second surface, wherein the second surface is opposed to the first surface, and at least one saw-toothed structure is formed on the second surface. The at least one LED unit is located at a lateral edge of the lateral light source processing module for emitting plural light beams. At least one of the plural light beams from the at least one LED unit is guided to the at least one saw-toothed structure by the light guide module. An included angle between a surface of the at least one saw-toothed structure and a normal line perpendicular to the first surface is a specified angle, so that the at least one light beam projected on the at least one saw-toothed structure is subject to total internal reflection. According to the specified angle, the at least one light beam is propagated along a corresponding direction.

In an embodiment, the light guide module is arranged between the at least one LED unit and the lateral light source processing module, or the at least one LED unit is arranged between the lateral light source processing module and the light guide module.

In an embodiment, the light guide module comprises at least one of a semi-cylindrical lens, a micro structure and an optical element.

In an embodiment, the lateral light source processing module further includes a speckle layer, and the speckle layer is formed on the first surface of the lateral light source processing module, wherein the at least one light beam propagated along the corresponding direction is transmitted through the speckle layer and then outputted to surroundings.

In an embodiment, the speckle layer at least includes plural speckles. The plural speckles are continuously distributed over the first surface, or the plural speckles are discontinuously distributed over the first surface, or the plural speckles are distributed as a specified profile.

In an embodiment, the speckle layer further includes at least one functional region, and the at least one functional region has a specified profile without any speckle.

In an embodiment, the at least one LED unit includes a first LED unit and a second LED unit, wherein the first LED unit and a second LED unit are located at a first lateral edge and a second lateral edge of the lateral light source processing module, respectively.

In an embodiment, the lighting device is an indoor lighting device or an outdoor lighting device.

In an embodiment, the specified angle is 45 degrees+/−3 degrees.

In an embodiment, the lateral light source processing module further includes a brightness enhancement film layer, which is formed on at least one surface of the at least one saw-toothed structure.

In an embodiment, the lateral light source processing module further includes a speckle layer and an image piece. The speckle layer is arranged between the at least one saw-toothed structure and the image piece. The plural light beams from the at least one LED unit are reflected by the at least one saw-toothed structure, sequentially transmitted through the speckle layer and the image piece, and then outputted to surroundings.

In accordance with another aspect of the present invention, there is provided a lateral light source processing module for receiving plural light beams laterally incident into the lateral light source processing module and outputting the plural light beams to surroundings. The lateral light source processing module includes a first surface and a second surface. The second surface is opposed to the first surface. At least one saw-toothed structure is formed on the second surface. An included angle between a surface of the at least one saw-toothed structure and a normal line perpendicular to the first surface is a specified angle, so that at least one light beam of the plural light beams projected on the at least one saw-toothed structure is subject to total internal reflection. According to the specified angle, the at least one light beam is propagated along a corresponding direction, transmitted through the first surface, and outputted to surrounding.

In an embodiment, the lateral light source processing module further includes a speckle layer. The speckle layer is formed on the first surface of the lateral light source processing module and at least includes plural speckles. The plural speckles are continuously distributed over the first surface, or the plural speckles are discontinuously distributed over the first surface, or the plural speckles are distributed as a specified profile.

In an embodiment, the lateral light source processing module further includes a speckle layer. The speckle layer further includes at least one functional region, and the at least one functional region has a specified profile without any speckle.

In an embodiment, the specified angle is 45 degrees+/−3 degrees.

In an embodiment, the lateral light source processing module further includes a brightness enhancement film layer, which is formed on at least one surface of the at least one saw-toothed structure.

In an embodiment, the lateral light source processing module is included in an indoor lighting device, an outdoor lighting device, a display device, a backlight module or a projecting device.

In an embodiment, the indoor lighting device or the outdoor lighting device includes at least one LED unit and a light guide module. At least one LED unit is located at a lateral edge of the lateral light source processing module. The light guide module is arranged between the at least one LED unit and the lateral light source processing module, or the at least one LED unit is arranged between the lateral light source processing module and the light guide module. At least one of the plural light beams from the at least one LED unit is guided to the at least one saw-toothed structure by the light guide module.

In an embodiment, the light guide module includes at least one of a semi-cylindrical lens, a micro structure and an optical element.

In an embodiment, the lateral light source processing module further includes a speckle layer and an image piece. The speckle layer is arranged between the at least one saw-toothed structure and the image piece. The plural light beams laterally incident into the lateral light source processing module are reflected by the at least one saw-toothed structure, sequentially transmitted through the speckle layer and the image piece, and then outputted to surroundings.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the structure of a conventional light guide plate;

FIG. 2 is a schematic side view illustrating a lateral light source processing module according to a first embodiment of the present invention;

FIG. 3 is a schematic side view illustrating a lateral light source processing module according to a second embodiment of the present invention;

FIG. 4 is a schematic side view illustrating a lateral light source processing module according to a third embodiment of the present invention;

FIG. 5 is a schematic front view illustrating an exemplary speckle layer used in a lateral light source processing module according to a fourth embodiment of the present invention;

FIG. 6 is a schematic front view illustrating an exemplary speckle layer used in a lateral light source processing module according to a fifth embodiment of the present invention;

FIG. 7 is a schematic front view illustrating some components of a lateral light source processing module according to a sixth embodiment of the present invention;

FIG. 8 schematically illustrates a lateral-lighting type lighting device having the lateral light source processing module of FIG. 2; and

FIG. 9 schematically illustrates another lateral-lighting type lighting device having the lateral light source processing module of FIG. 2.

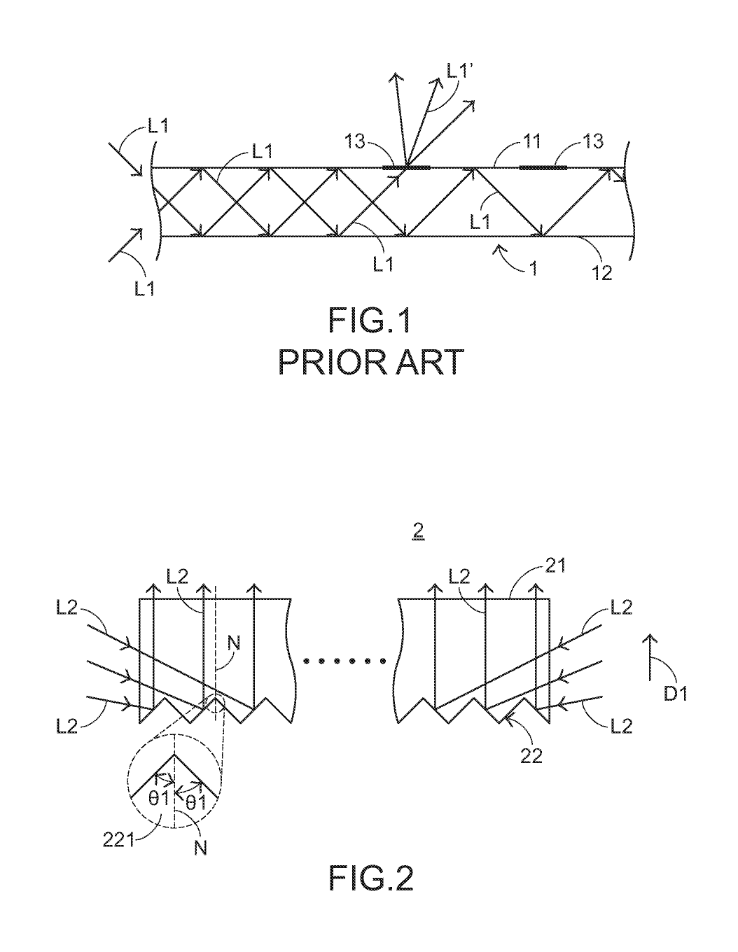

### DETAILED DESCRIPTION OF THE PREFERRED EMBODIMENT

FIG. 2 is a schematic side view illustrating a lateral light source processing module according to a first embodiment of the present invention. As shown in FIG. 2, the lateral light source processing module 2 has a first surface 21 and a second surface 22, wherein the first surface 21 and the second surface 22 are opposed to each other. Moreover, plural saw-toothed structures 221 are formed on the second surface 22 of the lateral light source processing module 2. There is an included angle θ1 between any surface of any saw-toothed structure 221 and a normal line N perpendicular to the first surface 21 of the lateral light source processing module 2.

Due to the included angle θ1 between the surface of the saw-toothed structure 221 and the normal line N, when any light beam L2 is laterally incident into the lateral light source processing module 2 and projected on any surface of any saw-toothed structure 221 to result in total internal reflection, the reflected light beam L2 is continuously propagated along a specified direction. After the light beam L2 is transmitted through the first surface 21 of the lateral light source processing module 2, the light beam L2 is outputted from the lateral light source processing module 2.

Those skilled in the art will readily observe that the included angle θ1 between the surface of the saw-toothed structure 221 and the normal line N may be designed according to the practical requirements. Consequently, the propagating direction of the reflected light beam L2 from any saw-toothed structure 221 can be controlled. From the above discussions, the lateral light source processing module 2 of the present invention has directivity. Consequently, by the lateral light source processing module 2 of the present invention, the regions to be illuminated (i.e. the directed regions by the reflected light beams L2) are very bright.

Moreover, since a great portion of the light beams L2 reflected by the saw-toothed structures 221 are directly transmitted through the first surface 21 of the lateral light source processing module 2 and outputted to the surroundings, it is not necessary to install the light-outputting dots on the first surface 21 of the lateral light source processing module 2. Under this circumstance, since the problems from the small over surface of the light-outputting dots are avoided, the light energy stored in the lateral light source processing module 2 may be quickly outputted to the surroundings.

In this embodiment, the main body of the lateral light source processing module 2 is a flat plate. In addition, the included angle θ1 between the surface of the saw-toothed structure 221 and the normal line N is designed to be a specified angle. It is preferred that the specified angle is 45 degrees+/−3 degrees. Consequently, when the plural light beams L2 are laterally incident into the lateral light source processing module 2 and projected on any surface of any saw-toothed structure 221 to result in total internal reflection, a great portion of the plural light beams L2 are reflected by the saw-toothed structures 221 and then continuously propagated along the direction D1.

The above lateral light source processing module is presented herein for purpose of illustration and description only. However, those skilled in the art will readily observe that numerous modifications and alterations may be made according to the practical requirements. For example, the included angles between the surfaces of different saw-toothed structures 221 and the normal line N are not always identical.

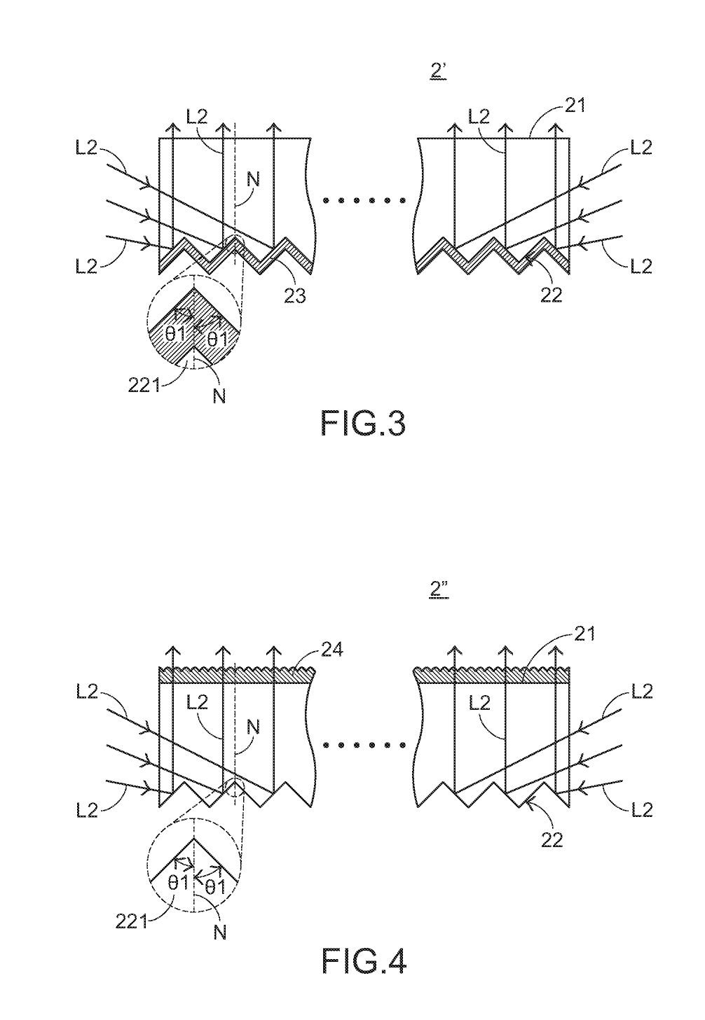

FIG. 3 is a schematic side view illustrating a lateral light source processing module according to a second embodiment of the present invention. Except that the lateral light source processing module 2′ further comprises a brightness enhancement film (BEF) layer 23, the configurations of the lateral light source processing module of this embodiment are substantially identical to those of the lateral light source processing module 2 of the first embodiment, and are not redundantly described herein. In addition, the brightness enhancement film layer 23 is formed on the surfaces of all saw-toothed structures 221. When the plural light beams L2 are projected on the brightness enhancement film layer 23, the plural light beams L2 are concentrated and reflected by the brightness enhancement film layer 23. Moreover, the portion of the light beams that are subject to total internal reflection on the saw-toothed structures 221 but do not travel through the first surface 21 will be reflected back to the saw-toothed structures 221 by the first surface 21, and then reflected by the saw-toothed structures 221 again to be outputted to the surroundings through the first surface 21 of the lateral light source processing module 2′. In other words, the brightness enhancement film layer 23 has a function of recycling and reusing the light.

FIG. 4 is a schematic side view illustrating a lateral light source processing module according to a third embodiment of the present invention. Except that the lateral light source processing module 2″ further comprises a speckle layer 24, the configurations of the lateral light source processing module 2″ of this embodiment are substantially identical to those of the lateral light source processing module of the first embodiment and the second embodiment, and are not redundantly described herein. In addition, the speckle layer 24 is formed on the first surface 21 of the lateral light source processing module 2″. The speckle layer 24 is used to provide a function of mixing the light beams reflected by the saw-toothed structures 221. Consequently, the light beams outputted from the speckle layer 24 to the surroundings are uniformly mixed white light. In this embodiment, the speckle layer 24 comprises plural speckles, which are distributed over the entire first surface 21.

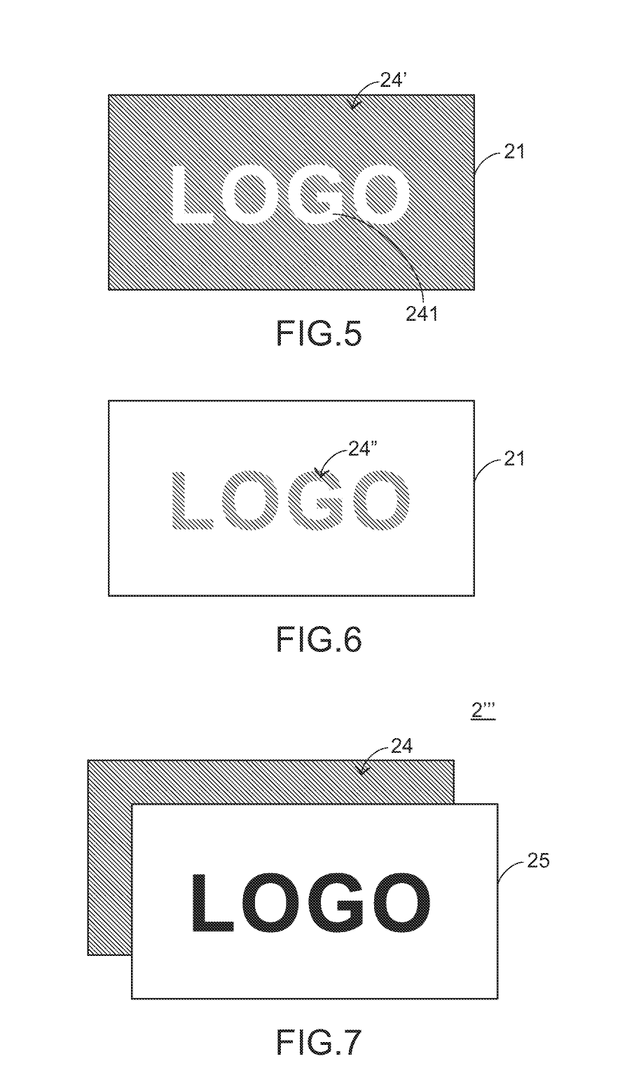

FIG. 5 is a schematic front view illustrating an exemplary speckle layer used in a lateral light source processing module according to a fourth embodiment of the present invention. Except that the speckle layer 24′ further comprises a functional region 241, the other components of the lateral light source processing module 2″ are similar to those of the lateral light source processing module of the third embodiment, and are not redundantly described herein. In this embodiment, no speckle is included in the functional region 241. Moreover, the functional region 241 has a specified profile. For example, the functional region 241 is denoted as a word “LOGO”. In other words, the speckles of the speckle layer 24′ are not distributed over the entire first surface 21.

Since the functional region 241 has no any speckle, the functional region 241 fails to provide the light mixing function. Under this circumstance, the light beams outputted from the specified profile “LOGO” and the light beams outputted from the region of the speckle layer 24′ excluding the specified profile “LOGO” (i e uniformly mixed white light) have distinguished effects.

FIG. 6 is a schematic front view illustrating an exemplary speckle layer used in a lateral light source processing module according to a fifth embodiment of the present invention. Except that the speckles of the speckle layer 24″ are distributed over a part of the first surface 21, the other components of the lateral light source processing module 2″ are similar to those of the lateral light source processing module of the third embodiment, and are not redundantly described herein. Moreover, the speckles of the speckle layer 24″ are distributed in a specified profile. For example, the speckle layer 24″ is denoted as a word “LOGO”. Since the region of the speckle layer 24″ with the specified profile “LOGO” has the speckles to provide the light mixing function, the light beams outputted from the speckle layer 24″ (i e uniformly mixed white light) and the light beams outputted from the region excluding the specified profile “LOGO” have distinguished effects.

From the fourth embodiment and the fifth embodiment, by the lateral light source processing module 2″ of the present invention, a specified region or a specified profile can attract people's attention in different ways or color effects. As a consequence, the lateral light source processing module of the present invention can provide an advertising effect or a special effect.

FIG. 7 is a schematic front view illustrating some components of a lateral light source processing module according to a sixth embodiment of the present invention. Except that the lateral light source processing module 2′″ further comprises an image piece 25 (e.g. a positive film, a color film, a slide or a transparency film), the other components of the lateral light source processing module are similar to those of the lateral light source processing module of the third embodiment, and are not redundantly described herein. Moreover, the image piece 25 is located at an outer side of the speckle layer 24, and arranged in the optical path of the light beams. Consequently, the light beams emitted by the light source are sequentially transmitted through the saw-toothed structures 221, the speckle layer 24 and the image piece 25 to exhibit the image of the image piece 25. As shown in FIG. 7, a portion of the image piece 25 (e.g. the specified profile “LOGO”) exhibits the red color, but another portion of the image piece 25 (e.g. the region excluding the specified profile “LOGO”) exhibits the green color. As a consequence, the lateral light source processing module of this embodiment can provide an advertising effect or a special effect.

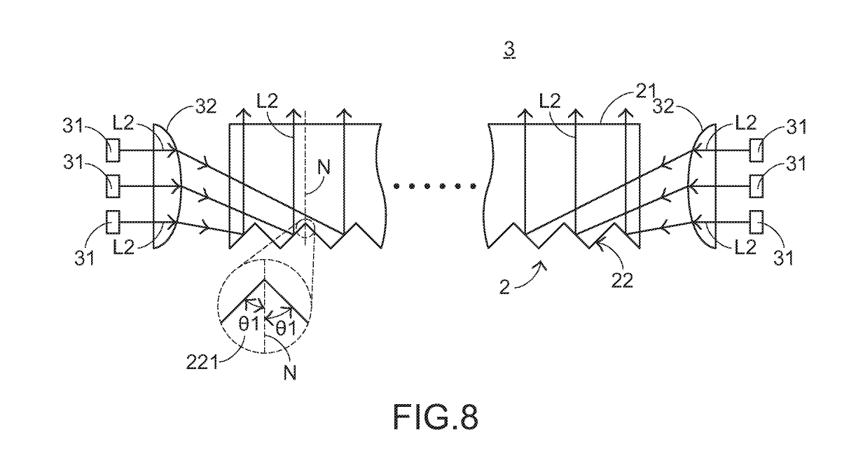

FIG. 8 schematically illustrates a lateral-lighting type lighting device having the lateral light source processing module of FIG. 2. The lateral-lighting type lighting device 3 is an indoor lighting device or an outdoor lighting device. As shown in FIG. 8, the lateral-lighting type lighting device 3 comprises plural LED units 31, a lateral light source processing module 2, and a light guide module 32. These LED units 31 are located at the lateral edges of the lateral light source processing module 2. Moreover, the light guide module 32 is arranged between the plural LED units 31 and the lateral light source processing module 2. By the light guide module 32, a great portion of the plural light beams L2 emitted by the plural LED units 31 are projected to the saw-toothed structures 221. Preferably, the light guide module 32 comprises at least one of a semi-cylindrical lens, a micro structure and an optical element.

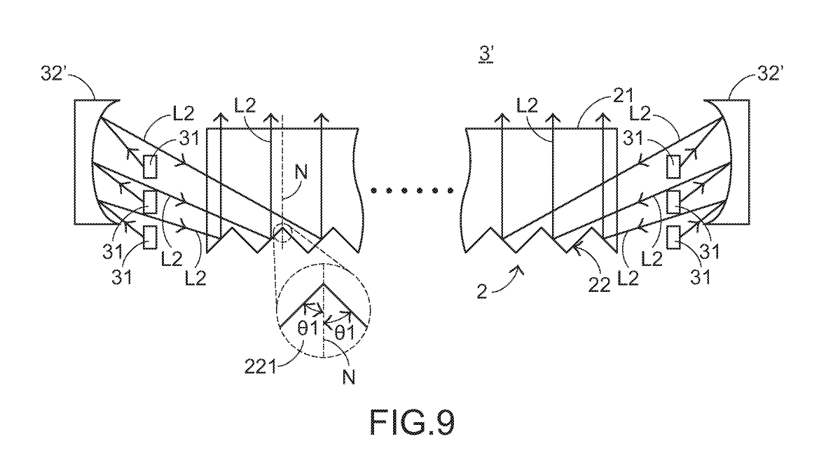

FIG. 9 schematically illustrates another lateral-lighting type lighting device having the lateral light source processing module of FIG. 2. Except for the following items, the configurations of the lateral-lighting type lighting device 3′ are substantially identical to those of the lateral-lighting type lighting device of FIG. 8, and are not redundantly described herein. In comparison with the lateral-lighting type lighting device of FIG. 8, the plural LED units 31 of the lateral-lighting type lighting device 3′ of this embodiment are arranged between the lateral light source processing module 2 and the light guide module 32′. The light beams L2 emitted by the plural LED units 31 are firstly projected to the light guide module 32′. By the light guide module 32′, a great portion of the plural light beams L2 are guided to the saw-toothed structures 221 of the lateral light source processing module 2.

Those skilled in the art will readily observe that the lateral light source processing modules of FIGS. 3-7 may be applied to the lateral-lighting type lighting device while retaining the teachings of the above embodiments. In addition, the lateral light source processing module of the present invention may be applied to a lighting device such as a wall lamp, an advertising lamp, a lamp cover, or the like. Alternatively, the lateral light source processing module of the present invention may be applied to a backlight module (e.g. a LCD display device) or a projecting device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A lighting device, comprising:
a lateral light source processing module comprising a first surface and a second surface, wherein said second surface is opposed to said first surface, and at least one saw-toothed structure is formed on said second surface;
at least one LED unit located at a lateral edge of said lateral light source processing module for emitting plural light beams; and
a light guide module, wherein at least one of said plural light beams from said at least one LED unit is guided to said at least one saw-toothed structure by said light guide module,
wherein an included angle between a surface of said at least one saw-toothed structure and a normal line perpendicular to said first surface is a specified angle, so that said at least one light beam projected on said at least one saw-toothed structure is subject to total internal reflection, wherein according to said specified angle, said at least one light beam is propagated along a corresponding direction.

2. The lighting device according to claim 1, wherein said light guide module is arranged between said at least one LED unit and said lateral light source processing module, or said at least one LED unit is arranged between said lateral light source processing module and said light guide module.

3. The lighting device according to claim 1, wherein said light guide module comprises at least one of a semi-cylindrical lens, a micro structure and an optical element.

4. The lighting device according to claim 1, wherein said lateral light source processing module further comprises a speckle layer, and said speckle layer is formed on said first surface of said lateral light source processing module, wherein said at least one light beam propagated along said corresponding direction is transmitted through said speckle layer and then outputted to surroundings.

5. The lighting device according to claim 4, wherein said speckle layer at least comprises plural speckles, wherein said plural speckles are continuously distributed over said first surface, or said plural speckles are discontinuously distributed over said first surface, or said plural speckles are distributed as a specified profile.

6. The lighting device according to claim 4, wherein said speckle layer further comprises at least one functional region, and said at least one functional region has a specified profile without any speckle.

7. The lighting device according to claim 1, wherein said at least one LED unit comprises a first LED unit and a second LED unit, wherein said first LED unit and a second LED unit are located at a first lateral edge and a second lateral edge of said lateral light source processing module, respectively.

8. The lighting device according to claim 1, wherein said lighting device is an indoor lighting device or an outdoor lighting device.

9. The lighting device according to claim 1, wherein said specified angle is 45 degrees+/−3 degrees.

10. The lighting device according to claim 1, wherein said lateral light source processing module further comprises a brightness enhancement film layer, which is formed on at least one surface of said at least one saw-toothed structure.

11. The lighting device according to claim 1, wherein said lateral light source processing module further comprises a speckle layer and an image piece, wherein said speckle layer is arranged between said at least one saw-toothed structure and said image piece, wherein said plural light beams from said at least one LED unit are reflected by said at least one saw-toothed structure, sequentially transmitted through said speckle layer and said image piece, and then outputted to surroundings.

12. A lateral light source processing module for receiving plural light beams laterally incident into said lateral light source processing module and outputting said plural light beams to surroundings, said lateral light source processing module comprising:
a first surface; and
a second surface opposed to said first surface, wherein at least one saw-toothed structure is formed on said second surface,
wherein an included angle between a surface of said at least one saw-toothed structure and a normal line perpendicular to said first surface is a specified angle, so that at least one light beam of said plural light beams projected on said at least one saw-toothed structure is subject to total internal reflection, wherein according to said specified angle, said at least one light beam is propagated along a corresponding direction, transmitted through said first surface, and outputted to surrounding.

13. The lateral light source processing module according to claim 12, further comprising a speckle layer, wherein said speckle layer is formed on said first surface of said lateral light source processing module and at least comprises plural speckles, wherein said plural speckles are continuously distributed over said first surface, or said plural speckles are discontinuously distributed over said first surface, or said plural speckles are distributed as a specified profile.

14. The lateral light source processing module according to claim 12, further comprising a speckle layer, wherein said speckle layer further comprises at least one functional region, and said at least one functional region has a specified profile without any speckle.

15. The lateral light source processing module according to claim 12, wherein said specified angle is 45 degrees+/−3 degrees.

16. The lateral light source processing module according to claim 12, further comprising a brightness enhancement film layer, which is formed on at least one surface of said at least one saw-toothed structure.

17. The lateral light source processing module according to claim 12, wherein said lateral light source processing module is included in an indoor lighting device, an outdoor lighting device, a display device, a backlight module or a projecting device.

18. The lateral light source processing module according to claim 12, wherein said indoor lighting device or said outdoor lighting device comprises at least one LED unit and a light guide module, wherein at least one LED unit is located at a lateral edge of said lateral light source processing module, wherein said light guide module is arranged between said at least one LED unit and said lateral light source processing module, or said at least one LED unit is arranged between said lateral light source processing module and said light guide module, wherein at least one of said plural light beams from said at least one LED unit is guided to said at least one saw-toothed structure by said light guide module.

19. The lateral light source processing module according to claim 18, wherein said light guide module comprises at least one of a semi-cylindrical lens, a micro structure and an optical element.

20. The lateral light source processing module according to claim 18, further comprising a speckle layer and an image piece, wherein said speckle layer is arranged between said at least one saw-toothed structure and said image piece, wherein said plural light beams laterally incident into said lateral light source processing module are reflected by said at least one saw-toothed structure, sequentially transmitted through said speckle layer and said image piece, and then outputted to surroundings.
